(19) United States
(12) Patent Application Publication
(10) Pub. No.: US 2011/0161496 A1
(43) Pub. Date: Jun. 30, 2011

(54) IMPLEMENTATION AND MANAGEMENT OF INTERNET ACCESSIBLE SERVICES USING DYNAMICALLY PROVISIONED RESOURCES

(76) Inventor: Jonathan C. Nicklin, Cambridge, MA (US)

(21) Appl. No.: 12/974,668

(22) Filed: Dec. 21, 2010

Related U.S. Application Data
(60) Provisional application No. 61/290,411, filed on Dec. 28, 2009.

(51) Int. Cl. G06F 15/173

(52) U.S. Cl. 709/226

(57) ABSTRACT

Systems and methods for providing a decentralized computing resource marketplace captures various attributes of a consumer's needs for remote computing services, such as cost, location, performance, network connectivity, reliability, hardware composition and service levels and identifies, provisions and manages remote resources offered by third parties on behalf of the consumers. Lease agreements may be brokered and enforced among consumers of remote computing services (e.g., storage) and the providers of such resources.

### CROSS-REFERENCE TO RELATED APPLICATIONS

This application claims priority to and the benefit of U.S. provisional patent application with Ser. No. 61/290,411, filed on Dec. 28, 2009, entitled “Implementation and Management of Internet Accessible Services Using Dynamically Provisioned Resources.”

### FIELD OF THE INVENTION

The present invention relates generally to the provision of remote computer services, and in particular, the provision of remote resources such as internet accessible, wide area and/or network attached storage.

### BACKGROUND OF THE INVENTION

As the world becomes more dependent on computerized data storage, various factors such as cost, capacity, transaction throughput and data availability become increasingly important to consumers that have significant storage requirements. In many cases, businesses are spending an increasing amount of their information technology budgets on network storage resources (e.g., network storage). As storage requirements grow, businesses are recognizing that the cost of storage involves much more than the cost of the physical resources. To accurately account for storage costs, additional factors must be considered, such as overhead of system administration, power, heating, ventilating, air conditioning, networking, security, rack space, software, service support agreements, hardware replacement, and disaster recovery systems.

Over the last decade, many technologies aimed at reducing the cost of storage have emerged. For example, Network Attached Storage (“NAS”) systems and Storage Area Network (“SAN”) systems have become popular alternatives to direct attached storage, due primarily to efficiencies gained in storage management and resource allocation. By centralizing the storage resources of multiple applications, administrative operations such as backup, restore, hardware replacement, and system monitoring become more efficient. Through the use of sophisticated storage management software, utilization efficiency has improved by limiting over-provisioning practices. But even with these gains in efficiency, companies remain focused in cutting costs and outsourcing non-core services. Utility and consumption-based online storage—often referred to as “cloud storage” or “storage as a service”—attempts to address this need.

The term cloud storage has become synonymous with remotely-provisioned data storage services. Current vendors of cloud storage include Amazon S3, Nirvanix, Rackspace's Cloudfile, Iron Mountain, Mozy Online Backup, and Cryptonite, to name a few. In an effort to increase profits and lock-in customers, vendors often provide a solution that requires customers to use vendor-specific software or develop software that conforms to a vendor-specific interface. This lack of interface standardization has made large scale adoption risky. Further, much of the software is expensive and error prone.

In addition to interoperability issues, the behavior of the services offered by cloud storage vendors is poorly defined. Neither users nor administrators may definitively know or understand where their data is stored, the technology used to store data, how the data is protected (both physically and legally), or what, if any, failure provisions may be in place. Also, cloud storage performance has proven unpredictable, at best. Long-haul networks have long latencies, which cause poor interactive performance. Lastly, many of the vendors have demonstrated large failure domains where localized failures have resulted in concurrent service disruptions or data loss for thousands of users.

### SUMMARY OF THE INVENTION

Accordingly, techniques and supporting systems as described herein address the above described problems, as well as other issues facing current remote data storage vendors and consumers. In order for consumers to fully realize the benefit of cloud storage, it must become both simpler to provision and more flexible to manage. Using exemplary aspects of the systems and techniques described herein, consumers are presented with a set of standard storage interfaces that, among other advantages, may not require customized software. An exemplary aspect of the system described herein provides access to remote storage with low latency, while tolerating and isolating localized failures in order to minimize disruptions. Further, consumers' data remains portable among various storage providers.

In one aspect of the present invention, a computer-implemented method is described for providing a decentralized computing resource marketplace by hosting a computing marketplace platform. The method includes receiving at a server consumer information from a prospective computing resource consumer, and the consumer information includes one or more characteristics of the prospective resource consumer and one or more desired data management objectives of the prospective resource consumer. The method also includes receiving at a server provider information from a computing resource provider. The provider information includes one or more characteristics of the resource provider, one or more available computing resources, and data management capabilities for each of the one or more available resources. The method further includes processing by a processor of the consumer information in order to select a resource provided by a selected resource provider. The selecting of the resource (and therefore a resource provider) is based at least in part on comparing the consumer information and the provider information. The method also includes entering into a provider agreement with the selected computing resource provider, the provider agreement directed to the allocation of the selected computing resource, as well as entering into a consumer agreement with the prospective computing resource consumer, the consumer agreement directed to the usage of the selected computing resource.

In an exemplary embodiment, the computing resource described in the above method is one of a hard drive, a solid data device, a battery backed RAM, a special purpose disk controller, a server, a RAID controller, a storage area network device, a network attached storage device, and a network attached disk. But one with ordinary skill in the art would understand that the computing resource could be any network device consistent with the spirit of this invention.

In a further exemplary embodiment, the consumer information in the above method includes one or more pieces of information such as consumer geographic location information, desired budget information, consumer network proximity information, desired latency information, desired bandwidth information, desired resource reliability information, desired resource performance information, desired resource capacity information, desired resource security information, desired resource storage technology information, desired service level duration information, and desired service level agreement type information.

In a further exemplary embodiment, the provider information in the above method includes one or more pieces of information such as provider geographic location information, desired cost information, provider network proximity information, latency information, bandwidth information, resource reliability information, resource performance information, resource capacity information, resource security information, resource storage technology information, desired service level duration information, and desired service level agreement type information.

In a further exemplary embodiment, the selecting of the resource in the method above is based at least in part on comparing the consumer information and the provider information to determine a list of best matches based on a ranking algorithm.

In another aspect of the invention, a computer-implemented method is described for providing a decentralized resource marketplace for computing resources by hosting a computing marketplace platform. The method includes receiving at a server consumer information from a prospective computing resource consumer, and the consumer information includes one or more characteristics of the prospective resource consumer and one or more desired data management objectives of the prospective resource consumer. The method also includes receiving at a server provider information from a computing resource provider. The provider information includes one or more characteristics of the resource provider, one or more available computing resources, and data management capabilities for each of the one or more available resources. The method further includes processing by a processor of the consumer information in order to select a resource provided by a selected resource provider. The selecting of the resource (and therefore a resource provider) is based at least in part on comparing the consumer information and the provider information. The method also includes facilitating a consumer/provider agreement between the selected computing resource provider and the prospective resource consumer, the consumer/provider agreement directed to the allocation and usage of the selected computing resource.

In an exemplary embodiment, the computing resource described in the above method is one of a hard drive, a solid data device, a battery backed RAM, a special purpose disk controller, a server, a RAID controller, a storage area network device, a network attached storage device, and a network attached disk. But one with ordinary skill in the art would understand that the computing resource could be any network device consistent with the spirit of this invention.

In a further exemplary embodiment, the consumer information in the above method includes one or more pieces of information such as consumer geographic location information, desired budget information, consumer network proximity information, desired latency information, desired bandwidth information, desired resource reliability information, desired resource performance information, desired resource capacity information, desired resource security information, desired resource storage technology information, desired service level duration information, and desired service level agreement type information.

In a further exemplary embodiment, the provider information in the above method includes one or more pieces of information such as provider geographic location information, desired cost information, provider network proximity information, latency information, bandwidth information, resource reliability information, resource performance information, resource capacity information, resource security information, resource storage technology information, desired service level duration information, and desired service level agreement type information.

In a further exemplary embodiment, the selecting of the resource in the method above is based at least in part on comparing the consumer information and the provider information to determine a list of best matches based on a ranking algorithm.

In another aspect of the present invention, a system is described that provides a decentralized computing resource marketplace. The system includes a module for receiving consumer information from a prospective computing resource consumer, and the consumer information includes one or more characteristics of the prospective resource consumer and one or more desired data management objectives of the prospective resource consumer. The system also includes a module for receiving provider information from a computing resource provider, the provider information including one or more characteristics of the resource provider, one or more available computing resources, and data management capabilities for each of the one or more available resources. The system further includes a module for processing the consumer information in order to select a resource provided by a selected resource provider. The selecting of the resource (and therefore a resource provider) is based at least in part on comparing the consumer information and the provider information. The system also includes a module for entering into a provider agreement with the selected computing resource provider, the provider agreement directed to the allocation of the selected computing resource, as well as entering into a consumer agreement with the prospective computing resource consumer, the consumer agreement directed to the usage of the selected computing resource.

In an exemplary embodiment, the computing resource described in the above system is one of a hard drive, a solid data device, a battery backed RAM, a special purpose disk controller, a server, a RAID controller, a storage area network device, a network attached storage device, and a network attached disk. But one with ordinary skill in the art would understand that the computing resource could be any network device consistent with the spirit of this invention.

In a further exemplary embodiment, the consumer information in the above system includes one or more pieces of information such as consumer geographic location information, desired budget information, consumer network proximity information, desired latency information, desired bandwidth information, desired resource reliability information, desired resource performance information, desired resource capacity information, desired resource security information, desired resource storage technology information, desired service level duration information, and desired service level agreement type information.

In a further exemplary embodiment, the provider information in the above system includes one or more pieces of information such as provider geographic location information, desired cost information, provider network proximity information, latency information, bandwidth information, resource reliability information, resource performance information, resource capacity information, resource security information, resource storage technology information, desired service level duration information, and desired service level agreement type information.

In a further exemplary embodiment, the selecting of the resource in the system above is based at least in part on comparing the consumer information and the provider information to determine a list of best matches based on a ranking algorithm.

In another aspect of the present invention, a system is described that provides a decentralized resource marketplace for computing resources. The system includes a module for receiving consumer information from a prospective computing resource consumer, and the consumer information includes one or more characteristics of the prospective resource consumer and one or more desired data management objectives of the prospective resource consumer. The system also includes a module for receiving provider information from a computing resource provider, the provider information including one or more characteristics of the resource provider, one or more available computing resources, and data management capabilities for each of the one or more available resources. The system further includes a module for processing the consumer information in order to select a resource provided by a selected resource provider. The selecting of the resource (and therefore a resource provider) is based at least in part on comparing the consumer information and the provider information. The system also includes a module for facilitating a consumer/provider agreement between the selected resource provider and the prospective resource consumer, the consumer/provider agreement directed to the allocation and usage of the selected resource.

In an exemplary embodiment, the computing resource described in the above system is one of a hard drive, a solid data device, a battery backed RAM, a special purpose disk controller, a server, a RAID controller, a storage area network device, a network attached storage device, and a network attached disk. But one with ordinary skill in the art would understand that the computing resource could be any network device consistent with the spirit of this invention.

In a further exemplary embodiment, the consumer information in the above system includes one or more pieces of information such as consumer geographic location information, desired budget information, consumer network proximity information, desired latency information, desired bandwidth information, desired resource reliability information, desired resource performance information, desired resource capacity information, desired resource security information, desired resource storage technology information, desired service level duration information, and desired service level agreement type information.

In a further exemplary embodiment, the provider information in the above system includes one or more pieces of information such as provider geographic location information, desired cost information, provider network proximity information, latency information, bandwidth information, resource reliability information, resource performance information, resource capacity information, resource security information, resource storage technology information, desired service level duration information, and desired service level agreement type information.

In a further exemplary embodiment, the selecting of the resource in the system above is based at least in part on comparing the consumer information and the provider information to determine a list of best matches based on a ranking algorithm.

It is to be understood that both the foregoing general description of the invention and the following detailed description are exemplary, but are not restrictive, of the invention.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 illustrates an exemplary network architecture diagram of the decentralized computing resource marketplace;

FIG. 2 illustrates an exemplary network diagram detailing computer or software application interaction with storage software;

FIG. 3 illustrates an exemplary logical diagram showing a virtual block device acting as an abstraction layer that provides a logically consecutive address space for physically non-contiguous block storage;

FIG. 4 illustrates an exemplary process flow diagram summarizing certain operational aspects of the system and the interactions among major system components; and

FIG. 5 illustrates an exemplary process flow diagram in which host providers are able to bid for the right to provide network resources to consumers.

### DETAILED DESCRIPTION

The systems and methods described herein facilitate the creation, management, and operation of an “Internet Marketplace” that allows users to locate, lease and manage remote online storage services where the remote online storage services are enabled using resources leased from, or collocated at, a third party. Due to the large number of data storage service providers that exist, or that may be enabled, the marketplace may include entities dispersed across a large geographic area without significant capital investment. In placing these services in an online marketplace, a consumer gains unified access to, and management of, storage services that may charted to satisfy a variety of application level requirements including cost, performance, availability, security and fault tolerance.

The systems and methods described herein facilitate the purchase of or subscription to dynamically-constructed internet-accessible storage services, using network resources. In some cases, these network resources may be dedicated, or, in some cases, leased from host providers. By participating in a marketplace where host providers offer their services, users benefit from competition between providers by way of reduced cost of storage, better proximity to storage, tiered service levels commensurate with costs, increased diversity in storage services offered, and increased availability.

One advantage of such a marketplace is the ability to allow any host service provider to participate in an open market for the provision of online storage services. Storage software components are often sufficiently generic, and many providers with network accessible servers may participate in the online storage marketplace. This benefits consumers in multiple ways. For instance, as more providers compete to deliver storage resources, the cost to consumers decreases. Also, the greater the number of providers, the greater the likelihood that consumers will find local storage options that meet their specific needs.

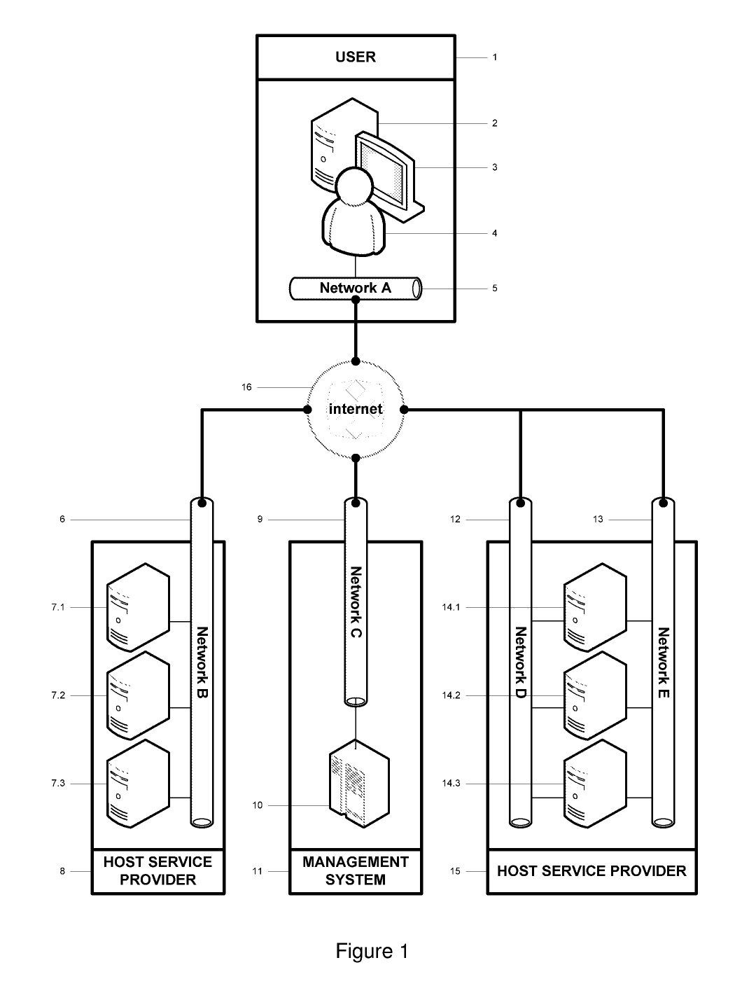

FIG. 1 illustrates one possible architectural arrangement of system components for implementing various embodiments of the remote storage management system and performing the associated methods. Specifically, a network supports a consumer 1, a host provider 8, and a management system 11, all connected, directly or indirectly, by the Internet 16. One with ordinary skill recognizes that the consumer may be an individual, a small business, a large corporation, or a department or subsidiary of a large company. Additionally, the host provider may be an individual, a small business, a large corporation, or a department or subsidiary of a large company, among other things.

The consumer 1 generally operates using various combinations of a client 2, a display/user interface 3, and a user 4. The client 2 may be a desktop computer, application server, storage device, storage gateway or mobile device capable of communicating with internetworked machines using a network layer protocol such as IP or Internet Protocol Security (“IPSec”), transport layer protocol such as User Datagram Protocol (“UDP”) or Transmission Control Protocol (“TCP”), and an application layer protocol such as Internet Small Computer System Interface (“iSCSI”), although other communication paradigms are possible and are within the spirit of the design. The consumer 1 may interact with management system 10 in order to purchase resources, provision resources, or manage resources that are physically accessed via machines 7.1, 7.2, 7.3, 14.1, 14.2, 14.3. In this example, machines 7.1, 7.2, 7.3, 14.1, 14.2 and 14.3 all run storage software which allows the management system 10 to remotely provision and manage storage resources. In this example, data storage is de-centralized while management coordination is centralized. However, nothing prevents the use of multiple management systems, clustered or otherwise decentralized, as may be required for a fault tolerant solution.

The host provider 8 may provide an Internet-accessible service facilitating metered or non-metered usage of one or more network resources, such as server hardware, storage hardware, network hardware, network bandwidth, and/or administrative services. In some cases, an arbitrary network-accessible server may be converted into a metered online storage resource. Specifically, software may be run on a server resource that is leased from or collocated at a provider. The software may configure the server to securely host data on locally accessible storage, subject to a service agreement. Unlike conventional software that converts a generic server into a storage resource (i.e., “SAN in a box” software available from vendors such as LeftHand Networks), the methods and systems described herein allow the storage resources to participate in the computing resource marketplace.

Other services related to providing access to computerized data storage may include, for example, a network accessed server with access to locally accessible network attached storage. Still referring to FIG. 1, a host provider 8, may provide access to general purpose servers 7.1, 7.2, and 7.3 via network 6. Each of these servers 7.1, 7.2, and 7.3 may differ in composition and may include different characteristics such as numbers, makes, and models of processors, operating system software, disks, memories, network controllers, disk controllers, power supplies, and management software. In the preferred embodiment, host provider 8 charges fees related to the cost, quality, and service level agreement associated with components comprising the servers 7.1, 7.2, and 7.3. In some instances, the servers 7.1, 7.2, and 7.3 may include one or more virtual servers, arranged as multiple instances of various operating systems and application software on a single physical device.

Any number of host providers 8 may participate in the computing resource marketplace, each offering different storage services and various levels of service and pricing. For example, host service provider 15 may offer servers 14.1, 14.2 and 14.3 which are connected to independent networks 12 and 13. Host service provider 15 may charge an additional fee for such a network configuration, as it would have better service availability than a singularly connected provider. However, the total cost of servers 14.1, 14.2 and 14.3 may be less that 7.1, 7.2, and 7.3, because host service provider 8 uses higher quality components or offers a better service level agreement. Alternative network topologies are possible and contemplated, and thus various costs may be associated with different network configurations. As such, the embodiments of the invention described herein should not be understood as limited to any particular network topology or network configuration(s).

Management system 11 includes various combinations of special-purpose software and hardware 10 configured to provide functions such as (i) tracking the inventory of resources accessible from host providers, (ii) providing user interfaces for procurement of storage services, (iii) providing user billing functions, (iv) managing provider lease agreements, (v) managing remote resources, and (vi) monitoring and configuration of network accessible resources. These functional components may be implemented as individual components or applications, or, in some cases, combined in various forms to achieve the same functional goal. Further, optimized implementations may include or exclude certain functional components and arrive at an implementation within the spirit of the invention described herein.

It is understood that management system 11 may contain software and hardware 10 connected to the Internet 16 via network 9. In this way, the management system 11 is capable of communicating with consumer 1 and various host service providers 8 and 15. Although FIG. 1 shows the management system 11 as residing on a single physical hardware device, it should be appreciated that the functionality of these components may be implemented on any number of computers in a distributed fashion. A communications network 5, 6, 9, 12 and 13 connects the client with the server. The communication may take place via any media such as standard telephone lines, LAN or WAN links (e.g., T1, T3, 56 kb, X.25), broadband connections (ISDN, Frame Relay, ATM), wireless links (802.11, Bluetooth, etc.), and so on. Preferably, the network can carry TCP/IP protocol communications, and HTTP/HTTPS requests made by the web browser and the connection between the client software and the server can be communicated over such TCP/IP networks. The type of network is not a limitation, however, and any suitable network may be used. Non-limiting examples of networks that can serve as or be part of the communications network include a wireless or wired Ethernet-based intranet, a local or wide-area network (LAN or WAN), and/or the global communications network known as the Internet 16, which may accommodate many different communications media and protocols.

In an exemplary embodiment, servers such as 7.1, 7.2, 7.3, 14.1, 14.2 and 14.3 may be general purpose servers capable of running software that converts locally accessible storage resources into network storage resources. In other implementations, the storage software may run as a user-land process on top of an operating system. However, nothing described herein prevents the software from being integrated into an operating system or functioning as an operating system. In the preferred embodiment, the storage software is compatible for use with Linux-based operating systems. However, nothing prevents equivalent software from being ported to or developed for other operating systems such as Berkeley Software Distribution (“BSD”) and Microsoft Windows.

### Storage Software

Storage software presents a network-accessible user interface that provides consumers with access to, and administrative management of, network and/or storage resources, which may be provisioned on their behalf. Network resources can include directly attached hard disks, solid data devices and battery-backed random access memory (“RAM”) made accessible through an integrated disk controller, special purpose disk controller, or a redundant array of independent disks (“RAID”) controller. Resources may also include network attached disks made accessible through a storage area network (i.e., iSCSI, Fibre Channel, etc.) and other network-accessible storage devices. Such devices may be accessed using application level programming interfaces (“APIs”) including, but not limited to Common Internet File System (“CIFS”), Network File System (“NFS”), Web-based Distributed Authoring and Versioning (“WebDAV”), Extensible Access Method (“XAM”), and vendor-specific Extensible Markup Language (“XML”) interfaces.

In some cases, the storage software may implement a virtualization layer that presents one or more network-accessible SCSI direct-access block devices configured to store data in virtual volumes. The virtual volumes, which may include virtual block devices, may be made accessible to users as SCSI logical units attached to SCSI targets that are accessed by way of an iSCSI target, for example.

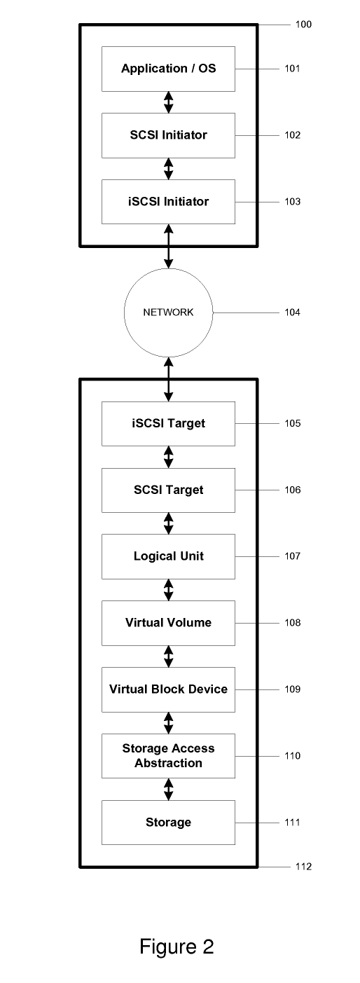

Referring to FIG. 2, a computer or software application 100 running or interacting with a further application or operating system 101 accesses storage made accessible using storage software 112. The consumer's application or operating system 101 may interact directly or indirectly with a SCSI initiator 102 and iSCSI initiator 103, which are each capable of issuing SCSI commands used to store and retrieve data from the physical devices. In such instances, the storage software 112 communicates with the initiator 102, 103 by way of the iSCSI target 105 and SCSI target 106 over the network 104.

SCSI command processing may be performed by a task manager implemented, in this example, in logical unit 107. The SCSI commands effect read and write transactions to logical blocks of a virtual volume 108 which, in turn, reads and writes logical blocks to a virtual block device 109. The virtual block device 109 may coordinate with physical devices to read and write data using a storage abstraction layer 110. The abstraction layer 110 can virtualize the access methods and programming interfaces required to store data on storage 111. For example, layer 110 may implement an NFS client, CIFS client, iSCSI initiator, or vendor-specific XML API.

It is understood by a person having ordinary skill in the art that the above method for interaction between the computer or software application and the storage software is merely exemplary, and might be implemented in various manners consistent with the spirit of this invention.

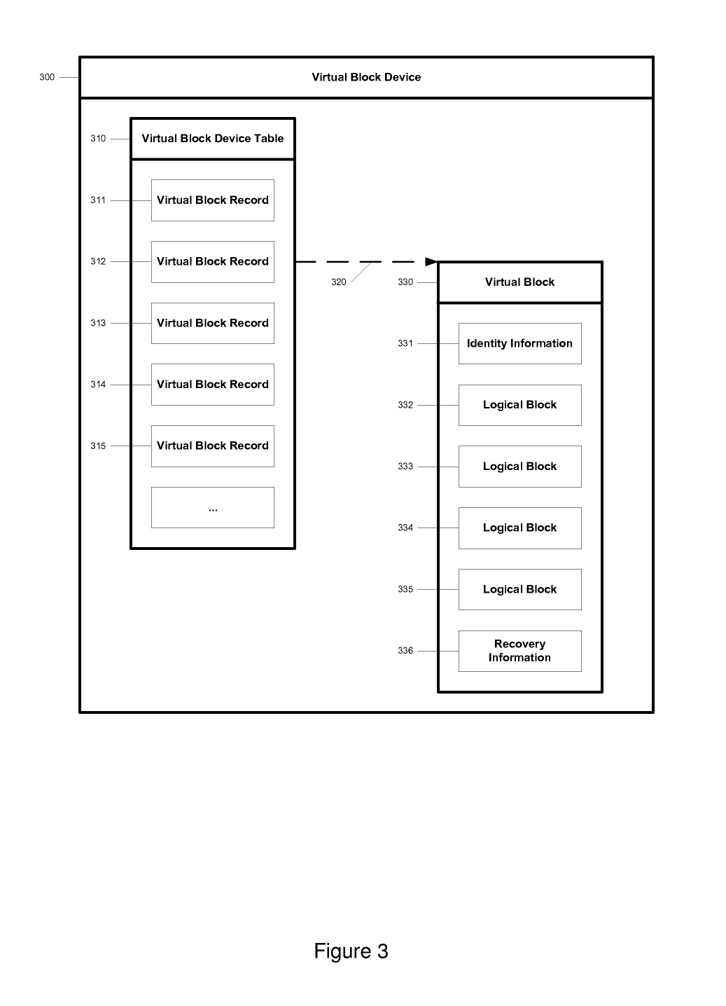

Referring now to FIG. 3, a virtual block device 300 acting as an abstraction layer provides a logically consecutive address space for physically non-contiguous block storage. Block device storage may exist on a single physical device or on multiple devices of heterogeneous sizes, makes and/or models, and accessed using one or more different access methods and routines. In certain cases, the access methods and routines may be implemented in the storage software for efficiency and supportability. For example, in instances in which network attached iSCSI storage devices are used to construct a virtual block device, the storage software may implement an iSCSI initiator. However, nothing precludes the use of an existing iSCSI initiator (provided by the operating system, for example) which may then be abstracted using a system call interface. Further, in implementations in which network attached NFS storage is used to construct a virtual block device, an NFS client may be implemented in the storage software. In some cases, a pre-existing NFS client implemented by the operating system and abstracted by a system call interface may also be used.

In some implementations, a virtual block device operates as a multi-level database of logical blocks 332, 333, 334, and 335. A logical block represents the smallest addressable unit of storage presented by a virtual block device, as well as the smallest unit of storage access for a SCSI block device and is comprised of logically contiguous storage on a single storage device. To facilitate efficient storage utilization, a consecutive sequence of logical blocks is encapsulated within a virtual block 330. Virtual blocks can contains information 331 for verifying the identity of the virtual block and/or identifying the range of logical blocks that it contains. A virtual block may optionally include recovery information 336 for recovering from various software or media level failures.

A virtual block device includes many virtual blocks, which in turn refer to the logical blocks to which the virtual block device provides access. One function of the virtual block abstraction is to permit efficient distribution of logical blocks across independent storage devices. This abstraction reduces the storage requirements needed to track logical blocks that make up a virtual block device, as the larger the virtual block size, the more logical blocks it contains and the smaller the metadata overhead becomes.

A persistent table 310 provides mappings 320 that resolve access to virtual blocks 330 that make up a virtual block device. The table 310 includes records 311, 312, 313, 314 and 315 that list the identity and location of the storage device containing the virtual block 330 and a device relative identifier used to resolve access to a virtual block 330. In one exemplary embodiment, device identifiers stored in the tables may be opaque references to more detailed configuration information (i.e., an abstraction). For example, a fixed-sized, globally-unique identifier may be assigned to some or all accessible storage devices. The identifier may then be stored in a virtual block record 311-315 and referenced as an index and/or mapping 320 into a secondary configuration table containing a more detailed description of the device, such as a description of access methods it supports or uses. Essentially, the information available in the virtual block 311-315 may be used in the index/mapping 320 to facilitate access to a virtual block 330. Using this approach, the size of table 310 may be minimized while maximizing the abstraction capabilities of the mapping 320.

Virtual blocks 330 may be accessed using generic access methods that can read and write a contiguous sequence of bytes or, in some cases, storage access methods specific to the virtual block 330. For example, a virtual block 330 may be stored at an arbitrary offset in a file accessed using the NFS or CIFS protocol. Or, in the alternative, a virtual block may be stored at an arbitrary offset into a SCSI block device accessible on an iSCSI storage area network.

In one exemplary embodiment, an operating system call provides direct access to a directly attached block device. In this instance, direct access implies that the operating system's buffer cache and Input/Output (“I/O”) scheduling mechanisms are bypassed to the largest extent possible. In such cases, the local block device used to store virtual blocks comprising a virtual block device can be a RAID controller with a non-volatile write cache. Other, less efficient means of access may be used and are within the spirit of the design.

The virtual block devices are consumed as storage device elements of virtual volumes. In such instances, virtual volumes are presented to clients as SCSI direct access block devices and implement version 2 of the SCSI Block Command set (i.e., SBC-2), although the implementation of newer SCSI commands sets, such as SBC-3 and beyond, are functionally equivalent. Virtual volumes are addressed as SCSI logical units and made accessible via one or more iSCSI/SCSI targets by the storage software. A virtual volume may include one or more virtual block devices, a mode of operation and an access control definition.

The mode of operation defines the type of service(s) implemented by a volume. For example, a direct mode of operation provides access to storage managed by a virtual block device. That is, a logical address relative to a virtual volume is directly mapped to a logical address relative to a virtual block device. Further, the replication mode of operation provides disaster tolerance by replicating logical blocks across multiple virtual block devices. As such, a single operation relative to a virtual volume may invoke multiple operations relative to the virtual block devices that comprise the volume.

Access control parameters may define the visibility and accessibility of virtual volumes to an iSCSI initiator. For example, the identity of an initiator may be established using any combination of an initiator-name key from the iSCSI login protocol data unit, the specified user in a challenge-address-handshake-protocol (“CHAP”) negotiation, a source IP address, and/or the digital certificate/identifier used to establish a secure network transport (e.g., Secure Sockets Layer (“SSL”), IPSec, Secure Shell (“SSH”), etc.). The established identity may then be used during iSCSI target discovery and again when processing SCSI REPORT-LUNS commands. Persistent configuration information defines which volume/logical units are visible to consumers and the targets used to access them, as well as defining whether an initiator may read or write the logical unit.

The storage software 112 may also implement a full-featured iSCSI target, although use of an existing iSCSI target, such as iSCSI Enterprise Target (IET), may also be used. An iSCSI target provides an iSCSI initiator with access to SCSI targets—iSCSI is simply a SCSI transport protocol and is primarily responsible for ordered delivery of SCSI commands and data between an initiator and target.

Using the methods and systems described herein, consumers have access to many virtual volumes attached to a diverse set of SCSI targets distributed among many physical machines, and in some instances an iSCSI target may redirect an initiator to remote iSCSI targets. Such functionality is defined by the iSCSI specification and is made possible using information provided in the “list-targets” iSCSI command Protocol Data Unit (“PDU”) response and using error codes that trigger redirection exception handling. Redirection is handled transparently by the iSCSI initiator.

As stated above, the storage node software may operate on a diverse (in both physical architecture and location) set of hardware. In most instances, hardware complexities are abstracted using an operating system such as Linux. In instances in which hardware resources are leased, verification of system components may be implemented in the software, and the storage software may implement a method to generate an inventory of system components. Such an inventory may be generated by examining device level information accessible from “/proc” or using driver specific “ioctl” routines. Responsibility for the inventory is given to the management software, which is responsible for storage in either a persistent or volatile manner. Storage software can generate the inventory listing every time the software is reset, or on a pre-defined periodic basis. In this manner, the storage software can validate that hardware components have not been removed or otherwise replaced with components of lesser quality, by comparing the current inventory to an initial or previous inventory. By making the management system responsible for storing the inventory, a global view may be achieved that permits detailed analysis to ensure that failed components are not re-used in other services available from a provider. Even further, this inventory can be used to generate a hardware specific set of software. For example, the software may be tailored only to run on a server with hardware components that have a specific model and serial number. Such a method may be valuable in preventing software piracy and rogue storage nodes.

In other implementations, the storage software 112 delivers services using metered or usage-based resources. For example, the storage software 112 may implement a method to meter such resources. Ideally, the bandwidth usage is be metered on a per-user basis by counting the number of bytes of iSCSI protocol data units sent to or received from an initiator. Since the initiator is authenticated, appropriate chargeback is also possible. In some cases, the storage software generates a summary of usage, including, for example, time of access and bandwidth used to allow for discounting of “off hours” access. The summary may be generated and provided at scheduled intervals, based on an event (such as reaching a usage threshold), or on demand and provided to the consumer, entities providing the storage resources or both.

In addition to providing access to storage resources, the storage software 112 implements a number of additional functions that improve the usability of wide area storage. For example, the storage software 112 may facilitate formatting of a block device to host a file system, such as NTFS, Third Extended File System (“EXT3”), or Hierarchical File System (“HFS”), which may reduce bandwidth utilization, provisioning time and/or cost. Such functionality may be provided by implementing routines for initialization of supported file systems directly into the storage software 112. The same function may also be provided using existing software in conjunction with access provided by an administrative iSCSI target having local access to the block device. Such access permits an operating system, such as Linux or Windows, to mount an iSCSI target in “loopback” and initialize the target using software embedded in the operating system.

The storage software 112 may also include functions that improve user accessibility to data. In its native form, the storage software 112 provides a block device accessible via iSCSI, as consumers generally store file systems on these block devices. In some environments it is useful for consumers to have web access to files and data stored in the file systems contained on these block devices. For example, a consumer may need to access files from a mobile device that is not equipped with an iSCSI initiator, or, from a platform that does not support a specific file system. To accommodate this, the storage software 112 may interpret the contents of a block device as a file system. As an example, the storage software 112 may provide administrative access for mounting the device in loopback. One with ordinary skill in the art understands that mounting the device via a loop mount allows the operating system hosting the storage software 112 to interpret the contents of the block device as a file system.

Interpreting the contents of a block device as a file system permits the storage software 112 to provide access to files stored in supported file systems, using Hypertext Transfer Protocol (“HTTP”) or Secure HTTP (“HTTPS”). By rendering a tree of dynamically generated Hypertext Markup Language (“HTML”) pages corresponding to directories of the file system, the storage software 112 provides web-based access to a collection of file systems hosted on block devices. Specifically, the consumer can navigate the directory structure of the file system and download file data. As HTTP GET requests are executed on directories, dynamic HTML pages are created containing embedded links to immediate children (i.e., files and subdirectories). When a browser issues a HTTP GET request for a file, the storage software 112 can use knowledge of the file system schema to determine the data composition of a file in order to stream the contents to the consumer.

### Management Software

In one exemplary embodiment, the storage services are constructed from generic server components that are leased from, or collocated at, host providers 8 and 18. The management system 11 keeps detailed information describing systems and services that are leased, available for lease, or that may be specifically constructed for the purpose of being leased.

Elements that describe a server's capabilities are referred to herein as the server's “characteristics” or “attributes.” In one exemplary embodiment, the following attributes are tracked by the management software: central processing unit (“CPU”) type, frequency and mode; disk controller type, model, serial number, and non-volatile random access memory (“NVRAM”) capabilities; disk type, count, model, serial number, capacity and speed; memory type, size and speed; local area network type, speed and redundancy; wide area network type, speed, redundancy and provider; power supply redundancy, power grid provider and redundancy; collocation lease terms; server lease terms; network upload lease terms; network download lease terms; network location; and geographic location. One with ordinary skill in the art will recognize that any of these attributes may be null or otherwise disregarded in any implementation of the present invention, and also that other attributes may be tracked that are not listed above. The specified attributes may be persistently recorded on disk or other medium according to a schema that facilitates efficient searches using a variety of query strings constructed to sort results by arbitrary attributes.

In some cases, a relational (or other structured) database may provide such functionality, for example as a database management system which stores data related to the services and consumers utilizing the service. Examples of the database include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

The type of storage service that a server is able to provide often depends on the components used to construct the server. For example, disk quality and cost can vary widely across various servers. Certain statistics may be gathered to quantify disk quality, usage, performance, etc. For example, disk reliability of multiple servers can be compared using mean time before failure (“MTBF”) and bit error rate ratio (“BER”) statistics specified by the disk manufacturer. Other statistics may also be specified by the disk manufacturer. Disks with better statistics generally cost more money and are less prone to failure, and therefore, services constructed using drives with largely different statistics will vary in reliability and cost. For example, the management software 112 analyzes the inventory of available system components to determine a reliability rating for each component provided by the storage software 112. Specifically, a weighted sum of server attributes may be calculated that represents a relative reliability of a storage service, which may then be used to compare services offered by different providers.

The management software 112 may also track and enforce lease agreements among numerous consumers and service providers, each establishing and governing the use of particular storage service(s). For example, a lease agreement may specify that a consumer will be using a specific device for a specified duration of time at an established cost. In other cases, the lease agreements may specify a contract for use of any storage device so long as it has specific attributes and is available according to certain parameters, as previously described. Other attributes such as service levels agreements may also be considered and implemented by the management software.

The management system 11 may include software and hardware 10 as described above, and in some cases integrate with a web-accessible ecommerce service provider for billing and funds transfer associated with the lease agreements. Some agreements may be based on a fixed cost, whereas others may include dynamic charges for usage-based services such as network bandwidth, storage and transactions. Integration may vary, but in certain instances an XML-based API is made accessible using secure HTTP. Integration of third party ecommerce platforms, such as IBM's WebSphere, or development of customized software, while potentially more flexible, is not necessarily required.

The management system 11 also implements methods for enforcement and coordination of enforcement of the lease agreements. Such methods may include, but are not limited to, periodic scanning of lease and resource records for service expiration, propagation of resource utilization limits to storage nodes, and verification of payments. In some instances, enforcement responsibilities are shared between the management software and storage software.

In other cases, fraud prevention and guarding against unauthorized access to user data are also provided. In order to provide the scale of services to support the anticipated demand, the system components may be decentralized. Such an arrangement permits a high degree of failure isolation and widely distributed management. As such, the management functions may be designed to provide a high degree of security and to be tolerant of large network latencies. Also, in some exemplary embodiments, the storage system software enforces service level agreements and implements different chargeback policies for usage-based resources. Also, tight integration between the management and storage software components may support various administrative goals.

The management system 11 can also track and manage provider lease agreements that establish the terms for usage of network-accessible servers that are, in turn, used to construct the storage services. In one particular embodiment, a provider lease may include terms of service related to usage based services such as network bandwidth. While lease agreement “terms and conditions” may vary between providers, the basic cost of components is generally competitive. The management software may periodically scan for lease expirations and perform dependency analyses of services constructed from resources that span lease agreements. The management software can also validate service level agreements associated with provider lease agreements. For example, many service providers offer refunds when service is disrupted. Therefore, the management software (or, in some cases the storage software 112) may detect such outages and adjust payments accordingly.

The management system 11 may also be configured to automatically discover candidate provider lease agreements that are available on publicly published websites. By periodically accessing the web sites of well known host providers, the management software can compile a real-time view of market conditions with respect to the demand for, and provisioning and supply of shared network resources. Such functionality is particularly advantageous in finding promotional deals which can then be used to offer promotional rates on storage services associated with lease agreements, as well as new service providers.

The management system 11 may also orchestrate the construction of a single storage service that includes multiple servers leased under different agreements with various unrelated parties. For example, a consumer may require a device with capacity that exceeds any single server's capabilities. Or, a consumer may want to migrate data among different storage services to reduce cost. Providing such fluid data portability allows consumers to migrate their data among various vendors and technologies in an attempt to manage and/or minimize storage costs. Data may be migrated manually by the user or migrated automatically by the storage software. In some cases, data may be migrated among providers without impact to (or even knowledge of) the consumer. Such functionality promotes data portability and permits the implementation of “cost-seeking” storage that may dynamically move data among resources in response to changing market conditions, seeking, for example, the lowest possible cost, best performance, or a balance among the two.

For example, if a consumer is already a party to an agreement with a first resource provider, but the cost for early termination of that agreement is less than the amount of savings that could be expected by the consumer entering into an agreement with a second resource provider, then that consumer would financially benefit from the migration of his data between the different storage providers. In one case, the consumer may enter into a new agreement with the second resource provider. In another case, the marketplace platform may establish the agreements without the knowledge of the consumer in order to save the consumer money. This functionality permits the notion of cost-seeking storage that dynamically moves data based on market conditions, and also increases data portability to the ultimate benefit of the consumers.

The management software can also track and manage resource usage. Accordingly, it is capable of identifying and analyzing the precise resources that comprise existing storage services and what resources are available to construct new services. In such instances, the management software dynamically allocates, releases, and re-provisions resources based on an inventory that changes over time and in response to market conditions. While there are many ways to implement a resource reservation system, the described system provides a dynamically constructed storage resource from generic network accessible server components, the availability and cost of which are determined in an open market format that benefits all participants.

The management system 11 may also suggest strategies for optimizing resource allocation and utilization by relocating storage services. As some providers may establish limits on network bandwidth consumption, the management system can identify other accessible devices that have pre-paid, or are otherwise under-utilized as viable substitutes. If a suitable substitute exists, services may be relocated to take advantage of “free” or under utilized bandwidth. This method can be used to optimize the cost of storage services presented to the consumer or the cost of providing storage services to a consumer. This analysis may be done prior to the initial request for services, or as the services being used reach or exceed a particular threshold. In some cases, the substitution may occur automatically and without notice to the consumer or providers, whereas in other cases a notice (either self-executing or requiring approval) may be issued.

The management software also provides an Internet-accessible interface to a reservations system allowing consumers to browse, compare and provision storage services through a standard web browser. In one example, the consumer creates a profile using data describing the consumer himself and the types of resources he is interested in. The web services infrastructure, which implements the website or web presence, may be integrated into the management software or exist as a separate service. In the preferred embodiment, information from the reservation system is abstracted from the web service using an XML API capable of integration with technologies such as Asynchronous JavaScript and XML (“AJAX”).

The management software may also facilitate the online management of purchased storage resources. Specifically, consumers can define parameters including, but not limited to, access control lists, device parameters, logical unit number (“LUN”) mappings, and tuning parameters that affect storage operations (i.e., write-caching, etc). The role of the management software, in this case, is to coordinate a persistent record of the requested changes and propagate the changes to the relevant storage software node(s), where they are enforced. The consumer may use an intuitive user interface provided by a web service, or an XML application level interface accessible over HTTPS. However, other interfaces, such as a desktop application, and transport options are also possible.

The management software may also recommend storage services to consumers based on location. For example, a web-accessible service such as ip2location may be used to associate an Internet Protocol (“IP”) address with a zip code. Storage resources or services may be matched and/or recommended to consumers based on stated needs and/or profiles, typically captured as one or more attributes. For example, it may be possible to receive, or even automatically determine, the geographic location of a consumer (or their data processing resources) based on an IP address, and calculate the distance to the IP addresses from all leasable resources in an effort to minimize distance and theoretical latency. Further, the consumer's network connections may be provided or identified, in order to appropriately match connection and storage bandwidth with one or more providers. A web service such as Google maps may be used to determine or display the distance between the consumer and suggested storage services. By minimizing the distance between the consumer and the storage allocated to the consumer, performance of the storage service is potentially maximized by reducing latency, resulting in a significant positive impact on the performance of some applications, especially those requiring synchronous replication. More precise analysis of distance and latency is possible using these location-based technologies in conjunction with extended information provided by standard network debugging tools such as traceroute, which determines the routes the data packets travel between the consumer and storage. Note that the process described above is merely exemplary, and the location need not be determined dynamically, but it may be appropriate for the information to be provided manually, such as when a consumer is provisioning storage for a remote application or an administrator is doing so on a consumer's behalf.

A computerized system allows consumers to lease storage resources based on various attributes including, but not limited to, cost, geographic proximity, network proximity, latency, bandwidth, reliability, performance, storage technology and service level agreement. In some cases, consumers may input storage and/or processing preferences into a web service which produces a result set conforming to the input specification.

In some implementations, the management software may also facilitate an auction system that allows host providers 8 and 15 to bid on contracts for providing resources that can be used to construct a consumer-specified storage service. Consumers may automatically and/or anonymously bid on storage or network resources, while providers may anonymously bid on hardware supplier contracts. For example, the methods and systems described here in may facilitate agreements by receiving descriptions from users, hardware descriptions from providers, and capabilities of the storage software to find potential matches and initiate service contracts.

For example, the management software may translate a consumer's description of services into service attributes that providers must (or should) be able to satisfy in order to “win” the auction. For instance, suppose a consumer requests 256 gigabytes of highly reliable storage, with a maximum random access latency of 10 ms. The latency specification could be used, in conjunction with the performance characteristics of common storage solutions, to define geographic boundaries that the service provider must be located in. The host providers 8 and 15 may then bid for the network resource contract, and the returned results/list to the consumer might be just the winning bidder, or else may be a ranking of the host providers and their respective bids. More sophisticated implementations introduce subtle changes to the storage technology used, such as using solid state devices instead of traditional rotating media to tune the edges of the geographic boundaries. In this way, the software can balance disk access latency against network latency. More importantly, it provides a concrete description of what service a provider must be able to provide.

The management software also provides static and dynamic configuration information to storage nodes. This configuration information includes, but is not limited to, iSCSI target descriptions (e.g., LUN mappings, target names, user access controls, etc.), virtual volume descriptions (e.g., mode, access control definitions, block device composition, tuning parameters), virtual block device descriptions (e.g., size, storage composition, data encryption keys), access control descriptions (e.g., users, challenges, digital certificates, public keys), resource usage limits (e.g., network bandwidth) and software authentication codes (e.g., piracy prevention for storage software). Static information is typically delivered when a storage node is reset, while dynamic information may be delivered at any time. Given the sensitive nature of the configuration information, all exchanges between the management software and the storage software occur over a secure channel such as one established using SSL, SSH, IPSec, etc.

The management software also facilitates the analysis of resource availability and the requirements of storage services already under lease to suggest changes that optimize various attributes of storage service. The system can use dependency and resource availability information to coordinate the automatic movement of data between provider resources or notify consumers of the availability of improved storage service options. In some embodiments, data movement is handled completely by the storage node software. However, one with skill in the art would readily understand that consumer-guided data movement is also possible.

For example, suppose a consumer leases 256 gigabytes of storage from provider A, and provider B begins offering resources with similar attributes as provider A, but at half the cost, such that a significant cost savings may be achieved by migrating to provider B's services. In this case, the consumer may be presented with an option to switch providers, assuming contractual agreement considerations are adequately addressed. Or, in another case, a different provider may begin offering competitively priced services that are significantly closer to the consumer such that a significant performance improvement may be realized by moving to the new provider. In this case, the system is capable of notifying the consumer through email, the storage system interface, or other promotional forms of communication.

### USAGE EXAMPLES

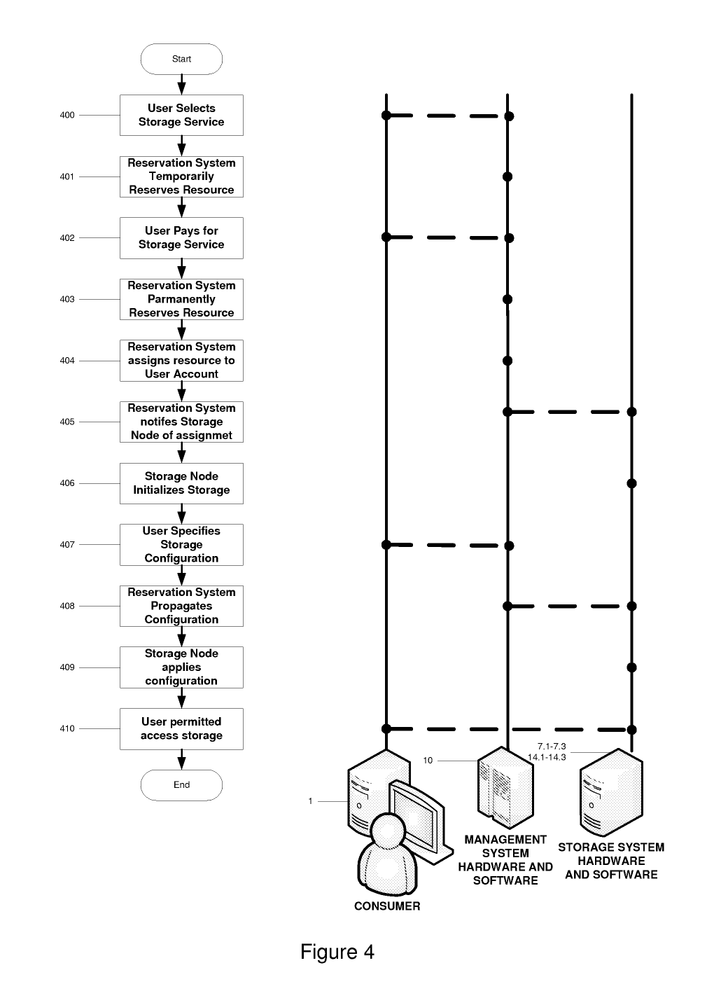

FIG. 4 summarizes certain operational aspects of the system and illustrates the interactions among the major system components. In step 400, the consumer selects a suitable storage service based on service attributes and availability, as determined by the reservation system. This might be an automated process where the system computes and returns a list of best-matched resources (and resource providers) for the consumer, based on a comparison of some or all of the consumer information and the resource information. For example, the selecting of the resource may be effectuated by presenting the consumer with a list of resource providers and/or resources that are the best matches, and then allowing the consumer to select which resource and resource provider to use.

An advantage of the techniques described herein is the ability to provide consumers with cost-effective storage resources that best match data processing and application support requirements. By way of example, a third backup copy of an engineer's development sandbox may not have the same storage requirements as the primary copy of a financial institution's client accounts database. The precise definition of “best match” is inherently application dependent. In some cases, cost will dominate the purchasing decisions. In other cases, such as synchronous replication, latency will be the dominant factor. In yet other cases, reliability will dominate. In many cases, a balance among the various metrics is struck according to a consumer-provided weighting algorithm. In any event, the methods and systems described herein are able to effectively provide consumers with network resources that match stated requirements and goals.

One with ordinary skill in the art would understand that any algorithm could be used to predict the best-matched resource and resource provider. The algorithm must simply weigh one or more of the various factors and arrive at a list of best options for the resource consumer, whether the option is simply one result or many results. How many results are returned by the algorithm, how the algorithm weighs the various factors, and any other specifics of the algorithm are not important in the present invention, so long as the algorithms bases its matched prediction on at least part of the consumer information and the resource/provider information.

In step 401, the reservation system temporarily reserves the resources required to construct the service. The resources are reserved until the consumer pays for the resources, releases the reservation or a timeout has expired. In step 402, the consumer inputs payment information such as a credit card number, bank account identifier, PayPal account identifier, or similar information. The reservation system can validate the payment method internally or in conjunction with an ecommerce payment system. Upon payment validation, the management system permanently reserves the resources comprising the storage service, in step 403, using a persistent record in a database. In addition, the resources are directly associated with the consumer in step 404.

In the preferred embodiment, steps 403 and 404 occur in a single transaction in order to ensure update atomicity. The reservation system may then determine which storage software node(s) requires configuration. Assuming that the provider resources required by the storage service are already leased and network accessible, the reservation node pushes a description of the storage service to the storage software node in step 405. In response, the storage software node provisions local resources, formats local data structure and otherwise prepares the locally accessible storage for access, pending a definition of access, in step 406. In step 407, the consumer provides such a definition. By interacting with the management software, it establishes iSCSI configuration parameters, authentication information, LUN mappings and other configuration information that specifies how a service can be accessed. The management software propagates this information to the appropriate storage software nodes in step 408. In step 409, the storage software accepts and applies the configuration parameters making the service accessible to the user. In step 410, the consumer is able to connect, store, and retrieve data directly from the storage software, using its iSCSI initiator.

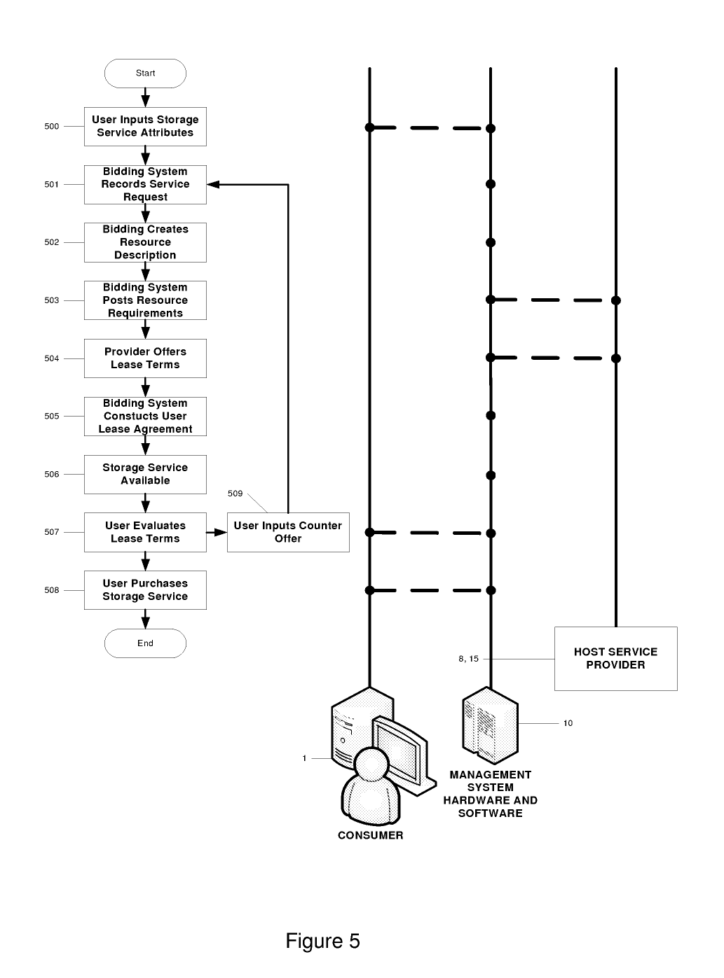

FIG. 5 illustrates one exemplary method in which providers are able to bid for the right to provide resources used to assemble consumer-defined storage services. In some cases, host providers are able to register their network accessible hardware resources and make them available for sale, leasing and/or conversion into reliable online storage. Registration may be accomplished, for example, by providing a description of the hardware resource including, but not limited to, resource geographic location, desired cost, network component composition, network connectivity, power connectivity, latency information, bandwidth information, agreement duration agreement, service level agreement, storage connectivity and lease terms, as well as any other resource performance information or network component metrics. It is also readily apparent to one with ordinary skill in the art that these factors are merely exemplary, and not meant to limit the scope of the invention described herein. Leasing of the resources may then occur in response to a consumer request for storage services.

In step 500, the consumer inputs a description of a storage service. Specifically, the consumer may input various attributes of the service, such as capacity, size, location, reliability and performance. In step 501, the bidding system records these attributes and translates them into a resource description in step 502. The resource description may be a record containing the minimum set of requirements that a provider must satisfy. For example, if the consumer specifies a maximum latency, a maximum distance could be calculated that defines a radius in which the service provider must be located. In step 503, the bidding system posts the requirements to providers. A post may consist of an entry on a webpage, an automatically generated direct email or a phone call, or any other effective manner of communication. Upon receiving a post, a provider can offer to provide resources by generating a lease agreement, in step 504. In response, the bidding system might create a consumer lease agreement, in step 505, based on the provider lease agreement submitted in step 504. Note that this abstraction is important to provide anonymity and allow the system to inject service fees. In step 506, the storage service is technically available for lease by the consumer. The consumer then agrees to or negotiates the leasing terms. If the consumer accepts the terms, then the consumer purchases the storage service, in step 508. If the consumer wishes to negotiate the terms of the agreement, he may provide a counter-offer, in step 509, which effectively restarts the bidding cycle from step 501.

As described above, one with ordinary skill in the art would understand that various other steps may be added or removed from the processes described herein and in FIGS. 4 and 5, or that steps may be performed in an alternative order, consistent with the spirit of the invention.

The information contained within this disclosure enables someone with ordinary skill in the art to develop a system for providing online storage services from generic hardware components leased or collocated at service provides. At a technological level, this involves building a specialized distributed reservations and management system that is tightly integrated with storage software. The technological approach employed is intended to allow an individual to create a scalable storage services business that spans a large geographic area without incurring large fixed capital startup costs.

As described above, the foregoing discussion discloses and describes merely exemplary embodiment of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology.

What is claimed is:

1. A computer-implemented method for providing a decentralized computing resource marketplace by hosting a computing marketplace platform, said method comprising:
receiving at a server consumer information from a prospective computing resource consumer, the consumer information including one or more characteristics of the prospective resource consumer and one or more desired data management objectives of the prospective resource consumer;
receiving at a server provider information from a computing resource provider, the provider information including one or more characteristics of the resource provider, one or more available computing resources, and data management capabilities for each of the one or more available resources;
processing by a processor of the consumer information to select a resource provided by a selected resource provider, the selecting of the resource based at least in part on comparing the consumer information and the provider information;
entering into a provider agreement with the selected computing resource provider, the provider agreement directed to the allocation of the selected computing resource; and
entering into a consumer agreement with the prospective computing resource consumer, the consumer agreement directed to the usage of the selected computing resource.

2. The method of claim 1, wherein the selected computing resource is selected from the group consisting of a hard drive, a solid data device, a battery backed RAM, a special purpose disk controller, a server, a RAID controller, a storage area network device, a network attached storage device, and a network attached disk.

3. The method of claim 1, wherein the consumer information includes information selected from the group consisting of: consumer geographic location information, desired budget information, consumer network proximity information, desired latency information, desired bandwidth information, desired resource reliability information, desired resource performance information, desired resource capacity information, desired resource security information, desired resource storage technology information, desired service level duration information, and desired service level agreement type information.

4. The method of claim 1, wherein the provider information includes information selected from the group consisting of: provider geographic location information, desired cost information, provider network proximity information, latency information, bandwidth information, resource reliability information, resource performance information, resource capacity information, resource security information, resource storage technology information, desired service level duration information, and desired service level agreement type information.

5. The method of claim 1, wherein the selecting of the resource is based at least in part on comparing the consumer information and the provider information to determine a list of best matches based on a ranking algorithm.

6. A computer-implemented method for providing a decentralized resource marketplace for computing resources by hosting a computing marketplace platform, said method comprising:
receiving at a server consumer information from a prospective computing resource consumer, the consumer information including one or more characteristics of the prospective computing resource consumer and one or more desired data management objectives of the prospective computing resource consumer;
receiving at a server provider information from a computing resource provider, the provider information including one or more characteristics of the computing resource provider, one or more available computing resources, and data management capabilities for each of the one or more available computing resources;
processing by a processor of the consumer information to select a computing resource provided by a selected computing resource provider, the selection of the computing resource based at least in part on comparing the consumer information and the provider information; and
facilitating a consumer/provider agreement between the selected resource provider and the prospective resource consumer, the consumer/provider agreement directed to the allocation and usage of the selected resource.

7. The method of claim 6, wherein the selected computing resource is selected from the group consisting of a hard drive, a solid data device, a battery backed RAM, a special purpose disk controller, a server, a RAID controller, a storage area network device, a network attached storage device, and a network attached disk.

8. The method of claim 6, wherein the consumer information includes information selected from the group consisting of: consumer geographic location information, desired budget information, consumer network proximity information, desired latency information, desired bandwidth information, desired resource reliability information, desired resource performance information, desired resource capacity information, desired resource security information, desired resource storage technology information, desired service level duration information, and desired service level agreement type information.

9. The method of claim 6, wherein the provider information includes information selected from the group consisting of: provider geographic location information, desired cost information, provider network proximity information, latency information, bandwidth information, resource reliability information, resource performance information, resource capacity information, resource security information, resource storage technology information, desired service level duration information, and desired service level agreement type information.

10. The method of claim 6, wherein the selecting of the resource is based at least in part on comparing the consumer information and the provider information to determine a list of best matches based on a ranking algorithm.

11. A system for providing a decentralized computing resource marketplace, said system comprising:
a module for receiving consumer information from a prospective computing resource consumer, the consumer information including one or more characteristics of the prospective resource consumer and one or more desired data management objectives of the prospective resource consumer;
a module for receiving provider information from a computing resource provider, the provider information including one or more characteristics of the resource provider, one or more available computing resources, and data management capabilities for each of the one or more available resources;
a module for processing the consumer information to select a resource provided by a selected resource provider, the selecting of the resource based at least in part on comparing the consumer information and the provider information;
a module for entering into a provider agreement with the selected computing resource provider, the provider agreement directed to the allocation of the selected computing resource; and
a module for entering into a consumer agreement with the prospective computing resource consumer, the consumer agreement directed to the usage of the selected computing resource.

12. The system of claim 11, wherein the selected computing resource is selected from the group consisting of a hard drive, a solid data device, a battery backed RAM, a special purpose disk controller, a server, a RAID controller, a storage area network device, a network attached storage device, and a network attached disk.

13. The system of claim 11, wherein the consumer information includes information selected from the group consisting of: consumer geographic location information, desired budget information, consumer network proximity information, desired latency information, desired bandwidth information, desired resource reliability information, desired resource performance information, desired resource capacity information, desired resource security information, desired resource storage technology information, desired service level duration information, and desired service level agreement type information.

14. The system of claim 11, wherein the provider information includes information selected from the group consisting of: provider geographic location information, desired cost information, provider network proximity information, latency information, bandwidth information, resource reliability information, resource performance information, resource capacity information, resource security information, resource storage technology information, desired service level duration information, and desired service level agreement type information.

15. The method of claim 11, wherein the selecting of the resource is based at least in part on comparing the consumer information and the provider information to determine a list of best matches based on a ranking algorithm.

16. A system for providing a decentralized resource marketplace for computing resources, said system comprising:
a module for receiving consumer information from a prospective computing resource consumer, the consumer information including one or more characteristics of the prospective computing resource consumer and one or more desired data management objectives of the prospective computing resource consumer;
a module for receiving provider information from a computing resource provider, the provider information including one or more characteristics of the computing resource provider, one or more available computing resources, and data management capabilities for each of the one or more available computing resources;
a module for processing the consumer information to select a computing resource provided by a selected computing resource provider, the selection of the computing resource based at least in part on comparing the consumer information and the provider information; and
a module for facilitating a consumer/provider agreement between the selected resource provider and the prospective resource consumer, the consumer/provider agreement directed to the allocation and usage of the selected resource.

17. The system of claim 16, wherein the selected computing resource is selected from the group consisting of a hard drive, a solid data device, a battery backed RAM, a special purpose disk controller, a server, a RAID controller, a storage area network device, a network attached storage device, and a network attached disk.

18. The system of claim 16, wherein the consumer information includes information selected from the group consisting of: consumer geographic location information, desired budget information, consumer network proximity information, desired latency information, desired bandwidth information, desired resource reliability information, desired resource performance information, desired resource capacity information, desired resource security information, desired resource storage technology information, desired service level duration information, and desired service level agreement type information.

19. The system of claim 16, wherein the provider information includes information selected from the group consisting of: provider geographic location information, desired cost information, provider network proximity information, latency information, bandwidth information, resource reliability information, resource performance information, resource capacity information, resource security information, resource storage technology information, desired service level duration information, and desired service level agreement type information.

20. The system of claim 16, wherein the selecting of the resource is based at least in part on comparing the consumer information and the provider information to determine a list of best matches based on a ranking algorithm.
